(19) United States
(12) Patent Application Publication
(10) Pub. No.: US 2014/0168258 A1
(43) Pub. Date: Jun. 19, 2014

(54) METHOD AND APPARATUS FOR AUGMENTING AN IMAGE OF A LOCATION WITH A REPRESENTATION OF A TRANSIENT OBJECT

(71) Applicants: David Alexander Dearman, San Bruno, CA (US); Raymond Rischpater, Sunnyvale, CA (US); Carmen Au, Sunnyvale, CA (US); Jason Wither, Sunnyvale, CA (US)

(72) Inventors: David Alexander Dearman, San Bruno, CA (US); Raymond Rischpater, Sunnyvale, CA (US); Carmen Au, Sunnyvale, CA (US); Jason Wither, Sunnyvale, CA (US)

(21) Appl. No.: 13/713,859

(22) Filed: Dec. 13, 2012

(51) Int. Cl. G06T 11/60

(52) U.S. Cl. CPC G06T 11/60
USPC 345/632

(57) ABSTRACT

A method, apparatus and computer program product are provided in order to augment an image of a location with a representation of a transient object. In the context of a method, an image of a location to be presented is identified. The method also includes identifying a transient object that is not in the image of the location, but that is anticipated to be at the location during at least one period of time. The method further includes causing the image of the location to be presented with augmentation that provides a representation of the transient object. A corresponding apparatus and computer program product are also provided.

### TECHNOLOGICAL FIELD

A method, apparatus and computer program product are provided in accordance with an example embodiment of the present invention in order to augment an image of a location and, more particularly, to augment an image of a location with a representation of a transient object.

### BACKGROUND

Services are available to provide images of a location to a user of computing device. For example, services are available that permit a user to identify a location, such as a street address, and to be presented with an image of the location. In this regard, FIG. 1 is an image of a streetscape that may be provided in response to a user's identification of the street address for one of the buildings in the image. As shown, the image depicted in FIG. 1 includes a street 10 and three buildings 12 positioned along the street. The image of FIG. 1 also includes an empty lot 14 between two of the buildings. These services are useful for a variety of purposes including providing a user with a preview of a particular location such that the user is better able to recognize an intended destination or other location. These services typically retrieve an image from a database based upon the identification of the location provided by the user. As such, the images that are presented by these services have generally been captured in advance.

Additionally, services are available that permit a user of a computing device to capture an image, such as an image of their surroundings, and to then present the image that has been captured along with additional information. In this regard, the additional information may include information associated with the various objects within the image, such as the identification of various buildings, landmarks, streets or the like that appear within the image. As such, a user may readily obtain additional information regarding objects in their immediate vicinity in order to, for example, locate a particular place of business, obtain a menu from a nearby restaurant or the like.

### BRIEF SUMMARY

A method, apparatus and computer program product are provided according to an example embodiment in order to augment an image of a location with a representation of a transient object. In this regard, the transient object is not otherwise included within the image of the location, but is anticipated to be positioned at the location during one or more periods of time. As such, the transient object may be represented by an augmented image that is generated in accordance with an example embodiment of the present invention in order to provide additional information to the user, such as information regarding a transient object that may only be positioned at the location during one or more periods of time.

In one embodiment, a method is provided that includes identifying an image of a location to be presented. For example, the identification of the image of the location may include causing the image of the location to be retrieved from a database or causing the image of the location to be captured. The method of this embodiment also includes identifying, with a processor, a transient object that is not in the image of the location, but that is anticipated to be at the location during at least one period of time. The method of this embodiment also includes causing the image of the location to be presented with augmentation that provides a representation of the transient object.

The transient object may have a predetermined appearance. As such, the method of this embodiment may include augmenting the image of the location with a representation having the predetermined appearance of the transient object. Alternatively, the method may include augmenting the image of the location with a representation of the transient object that has a generic appearance.

The method of one embodiment may also include receiving a request for information regarding the transient object and causing information to be presented regarding the at least one period of time during which the transient object is anticipated to be at the location. In one embodiment, one or more transient objects are anticipated to be at the location, such as during different periods of time. As such, the method of this embodiment may cause information to be presented by causing a schedule to be presented of the at least one period of time during which the one or more transient objects are anticipated to be at the location. In this embodiment, the method may also include receiving an indication of a selected time from the schedule, determining whether a respective transient object is anticipated to be at the location at the selected time and augmenting the image with the representation of the respective transient object that is anticipated to be at the location at the selected time. In this embodiment, the method augments the image only in instances in which the respective transient object is anticipated to be at the location at the selected time. The method of this embodiment may also cause the image of the location at the selected time to be presented with augmentation by augmenting the image of the location with the representation of a respective transient object that is anticipated to be at the location at the selected time.

In another embodiment, an apparatus is provided that includes at least one processor and at least one memory including computer program code with the at least one memory and the computer program code configured to, with the processor, cause the apparatus to at least identify an image of the location to be presented. The at least one memory and the computer program code may be configured to, with the processor, cause the apparatus of one embodiment to identify the image of the location by causing the image of the location to be retrieved from a database or causing the image of the location to be captured. The at least one memory and computer program code are configured to, with the processor, cause the apparatus of this embodiment to identify a transient object that is not in the image of the location, but that is anticipated to be at the location during at least one period of time. The at least one memory and the computer program code are further configured to, with the processor, cause the apparatus of this embodiment to cause the image of the location to be presented with augmentation that provides a representation of the transient object.

The transient object may have a predetermined appearance. As such, the at least one memory and the computer program code may be further configured to, with the processor, cause the apparatus to augment the image of the location with a representation having the predetermined appearance of the transient object. Alternatively, the at least one memory and the computer program code may be further configured to, with the processor, cause the apparatus to augment the image of the location with a representation of the transient object having a generic appearance.

The at least one memory and the computer program code may be further configured to, with the processor, cause the apparatus of one embodiment to receive a request for information regarding the transient object and cause information to be presented regarding the at least one period of time during which the transient object is anticipated to be at the location. One or more transient objects may be anticipated to be at the location, such as during different periods of time. The at least one memory and computer program code may be configured to, with the processor, cause the apparatus of this embodiment to cause information to be presented by causing a schedule to be presented of the at least one period of time during which the one or more transient objects are anticipated to be at the location. The at least one memory and the computer program code may also be configured to, with the processor, cause the apparatus of this embodiment to receive an indication of the selected time from the schedule, determine whether a respective transient object is anticipated to be at the location at the selected time and augment the image with the representation of the respective transient object that was anticipated to be the location at the selected time. In this embodiment, the at least one memory and the computer program code may be configured to, with the processor, cause the apparatus to augment the image only in an instance in which a respective transient object is anticipated to be at the location at the selected time. The at least one memory and the computer program code may also be configured to, with the processor, cause the apparatus of this embodiment to cause the image of the location at the selected time to be presented with augmentation by augmenting the image of the location with the representation of the respective transient object that was anticipated to be at the location at the selected time.

In a further embodiment, a computer program product is provided that includes at least one non-transitory computer-readable storage medium having computer-executable program code portions stored therein with the computer-executable program code portions including program code instructions for identifying an image of a location to be presented and identifying a transient object that is not in the image of the location, but that is anticipated to be at the location during at least one period of time. The computer-executable program code portions of this embodiment also include program code instructions for causing the image of the location to be presented with augmentation that provides a representation of the transient object.

The transient object may have a predetermined appearance. As such, the computer-executable program code instructions may also include program code instructions for augmenting the image of the location with a representation having the predetermined appearance of the transient object. Alternatively, the computer-executable program code portion may further include program code instructions for augmenting the image of the location with a representation of the transient object having a generic appearance.

The computer-executable program code portions of one embodiment may also include program code instructions for receiving a request for information regarding the transient object and causing information to be presented regarding the at least one period of time during which the transient object is anticipated to be at the location. One or more transient objects may be anticipated to be the location, such as during different periods of time. In this embodiment, the program code instructions for causing information to be presented may include program code instructions for causing a schedule to be presented of the at least one period of time during which the one or more transient objects are anticipated to be at the location. The computer-executable program code portions of this embodiment may also include program code instructions for receiving an indication of a selected time from a schedule, determining whether a respective transient object is anticipated to be at the location at the selected time and augmenting the image with the representation of the respective transient object that is anticipated to be at the location at the selected time. In this regard, the program code instructions may augment the image only in an instance in which a respective transient object is anticipated to be at the location at the selected time. In this embodiment, the program code instructions for causing the image of the location at the selected time to be presented with augmentation may include program code instructions for augmenting the image of the location with the representation of the respective transient object that is anticipated to be at the location at the selected time.

In yet another embodiment, an apparatus is provided that includes means for identifying an image of a location to be presented and means for identifying a transient object that is not in the image of the location, but that is anticipated to be at the location during at least one period of time. The apparatus of this embodiment also includes means for causing the image of the location to be presented with augmentation that provides a representation of the transient object.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is an image of a streetscape that may be presented upon a display of a computing device;

FIG. 2 is a block diagram of an apparatus that may be specifically configured in accordance with an example embodiment of the present invention;

FIG. 3 is a flow chart illustrating operations performed, such as by the apparatus of FIG. 2, in accordance with an example embodiment of the present invention;

FIG. 4 is an image of the streetscape of FIG. 1 that has been augmented with the representation of a transient object that has the predetermined appearance of the transient object in accordance with an example embodiment of the present invention;

FIG. 5 is an image of the streetscape of FIG. 1 that has been augmented with the representation of a transient object that has a generic appearance in accordance with an example embodiment of the present invention; and

FIG. 6 is an image of the streetscape of FIG. 1 that has been augmented with the representation of a transient object that has a generic appearance and that presents information regarding the at least one period of time during which the transient object is anticipated to be at the location in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

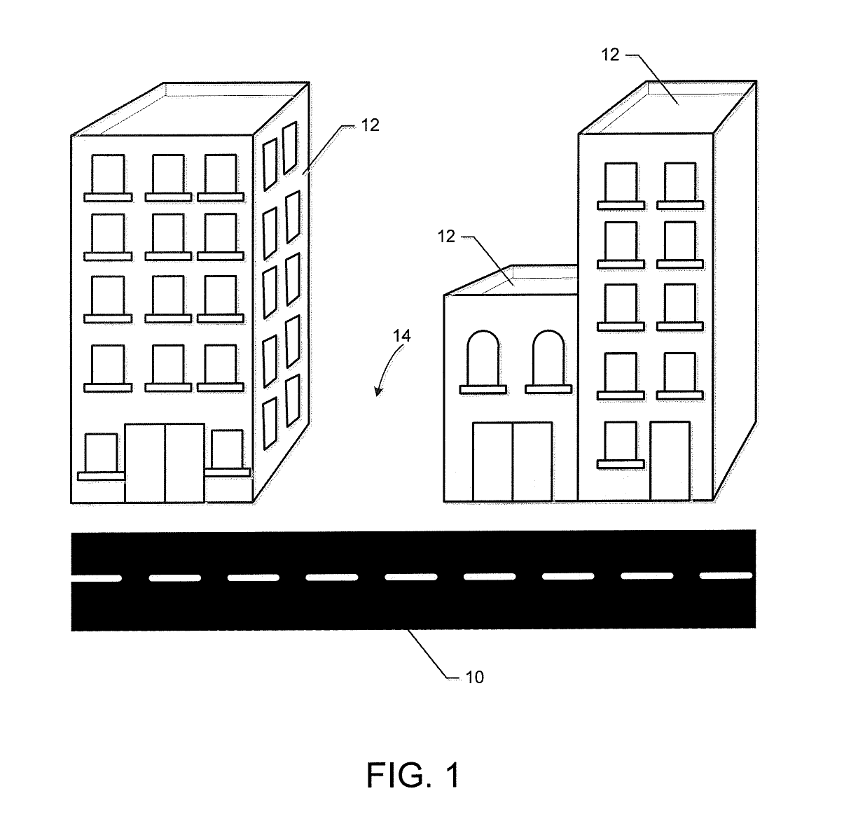

A method, apparatus and computer program product are provided according to an example embodiment in order to augment an image of a location, such as the image of a streetscape as shown in FIG. 1, with a representation of a transient object. As shown in FIG. 1, the transient object is not in the image of the location. However, the transient object is anticipated to be at the location during at least one period of time, such as during one or more periods of time other than the time at which the image of the location was captured. A method, apparatus and computer program product of an example embodiment may augment an image of a location with a representation of various types of transient objects that are positioned at the location on a temporary basis. The transient object may be scheduled to be positioned at the location on a periodic basis, such as a food truck that is parked at the location for a predefined period of time during lunch and/or for a predefined period of time during dinner. As another example of a transient object that is scheduled to be positioned at the location on a periodic basis, a farmer's market may be erected at the location for several hours on one or more days of the week. Still further, the transient object may be scheduled to be positioned at the location on an irregular basis, such as a concert that is scheduled to occur on Friday evening at 7:00 pm. While certain examples of transient objects are provided by way of illustration, other types of transient objects may be represented by the augmentation of the image of the location in accordance with the method, apparatus and computer program product of an example embodiment of the present invention.

In accordance with an example embodiment of the present invention, an apparatus 20 is depicted that is specifically configured to augment an image of a location with a representation of a transient object. The apparatus may be embodied by a computing device. In one embodiment, the computing device may be embodied as a server, a personal computer, a computer workstation or the like. Alternatively, the computing device may be embodied as a mobile terminal, such as a portable digital assistant (PDA), mobile telephone, smartphone, pager, mobile television, gaming device, laptop computer, camera, tablet computer, touch surface, video recorder, audio/video player, radio, electronic book, positioning device (e.g., global positioning system (GPS) device), or any combination of the aforementioned, and other types of voice and text communications systems.

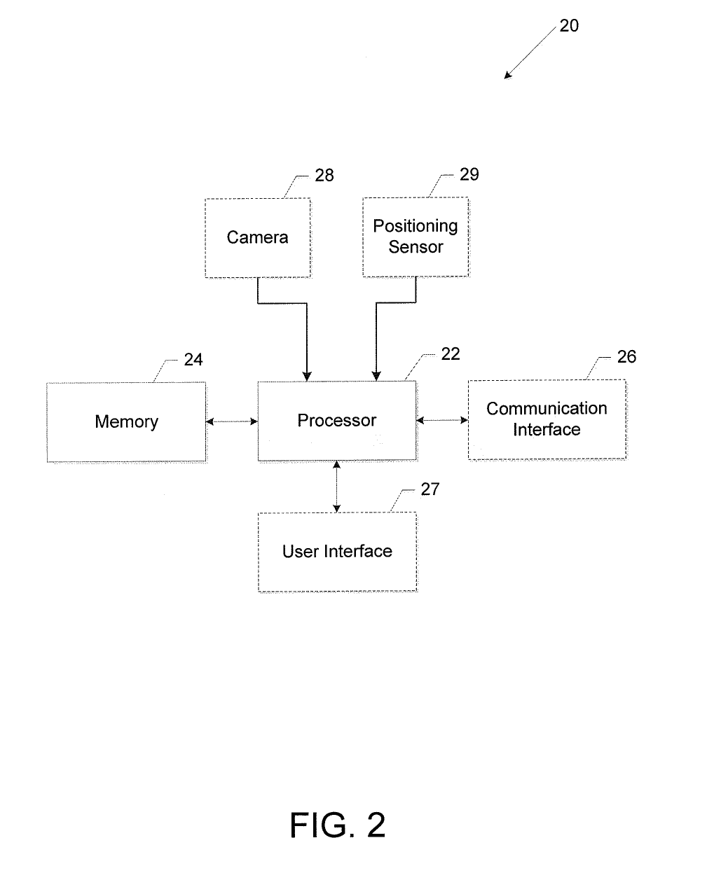

Regardless of its implementation, the apparatus 20 may include or otherwise be in communication with a processor 22 and a memory device 24, and optionally one or more other components as represented, for example, by the dashed outline of optional blocks in FIG. 2. It should be noted that while FIG. 2 illustrates one example of a configuration of an apparatus for augmenting an image of a location with a representation of a transient object, numerous other configurations may also be used to implement embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus 20 to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a head mounted display) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In one embodiment, the apparatus 20 also includes a communication interface 26 embodied in either hardware or a combination of hardware and software that is configured to receive and/or transmit data from/to the apparatus, such as a computing device that embodies the apparatus. For example, in an embodiment in which the apparatus is embodied by a server, the communication interface may be configured to communicate with a client device operated by the user so as to receive user input provided via the client device and to cause images to be presented via the user interface of the client device. In this regard, the communication interface may include, for example, an antenna (or multiple antennas) and supporting hardware and/or software for enabling communications wirelessly. Additionally or alternatively, the communication interface may include the circuitry for interacting with the antenna(s) to cause transmission of signals via the antenna(s) or to handle receipt of signals received via the antenna(s). In some instances, the communication interface may alternatively or also support wired communication. As such, for example, the communication interface may include a communication modem and/or other hardware/software for supporting communication via cable, digital subscriber line (DSL), universal serial bus (USB) or other mechanisms.

The apparatus 20 may also optionally include a user interface 27, such as in instances in which the apparatus is embodied by a computing device with which the user interacts. In these embodiments, the user interface may be in communication with the processor 22 to provide output to the user and, in some embodiments, to receive an indication of a user input. For example, the user interface may include a display and, in some embodiments, may also include a keyboard, a mouse, a joystick, a touch screen, touch areas, soft keys, a microphone, a speaker, or other input/output mechanisms. The processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor (e.g., memory 24, and/or the like).

In some example embodiments, such as in some instances in which the apparatus 20 is embodied by a computing device with which the user interacts, the apparatus may include an image capturing element, such as a camera 28, video and/or audio module, in communication with the processor 22. The image capturing element may be any means for capturing an image, video and/or audio for storage, display or transmission. As used herein, an image includes a still image as well as an image from a video recording. For example, in an example embodiment in which the image capturing element is a camera, the camera may include a digital camera capable of forming a digital image file from a captured image. As such, the camera may include all hardware (for example, a lens or other optical component(s), image sensor, image signal processor, and/or the like) and software necessary for creating a digital image file from a captured image. Alternatively, the camera may include only the hardware needed to view an image, while a memory device 24 of the apparatus stores instructions for execution by the processor in the form of software necessary to create a digital image file from a captured image. In an example embodiment, the camera may further include a processing element such as a co-processor which assists the processor in processing image data and an encoder and/or decoder for compressing and/or decompressing image data. The encoder and/or decoder may encode and/or decode according to, for example, a joint photographic experts group (JPEG) standard, a moving picture experts group (MPEG) standard, or other format.

In some embodiments, the apparatus 20 may include a positioning sensor 29, such as in some instances in which the apparatus is embodied by a computing device with which the user interacts. The positioning sensor may include, for example, a GPS sensor, an assisted global positioning system (A-GPS) sensor, a Bluetooth (BT)-GPS mouse, other GPS or positioning receivers or the like. However, in one example embodiment, the positioning sensor may include a pedometer or inertial sensor. In this regard, the positioning sensor may be capable of determining a location of the computing device that embodies the apparatus, such as, for example, longitudinal and latitudinal directions of the computing device, or a position relative to a reference point such as a destination or start point. Information from the positioning sensor may then be communicated to a memory 24 of the apparatus.

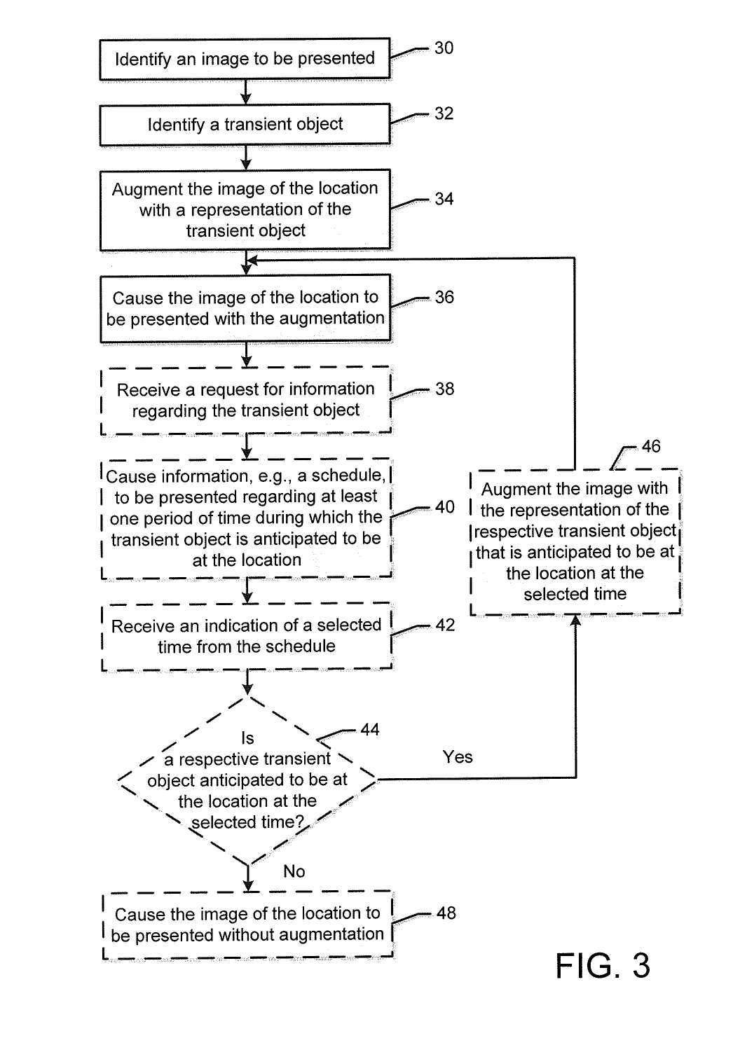

Referring now to FIG. 3, the operations performed, such as by the apparatus 20 of FIG. 2, in accordance with an example embodiment of the present invention are illustrated. As shown in block 30 of FIG. 3, the apparatus may include means, such as the processor 22 or the like, for identifying an image of a location to be presented. The image of the location may be identified in various manners. In one embodiment, the image of the location is identified by first identifying the location that is to be the subject of the image. For example, a user of a computing device may identify the location, such as by entering a street address, the name of a landmark or otherwise. In this embodiment, the apparatus, such as the processor, may identify the image of the location by causing the image of the location to be retrieved from a database, such as a database maintained by the memory 24. For example, the image of a location may be retrieved from the database based upon the identification of the location provided by the user. In one embodiment, the image that is retrieved is associated with the location that is identified by the user, such as by including the location within metadata associated with the image. Alternatively, the apparatus, such as processor, the camera 28 or the like, may cause the image of the location to be captured, such as by capturing a live video. In this embodiment, the apparatus, such as the processor, the positioning sensor 29 or the like, may identify the location at which the image is captured in various manners including based upon information provided by the positioning sensor concurrent with the capture of the image.

As shown in block 32 of FIG. 3, the apparatus 20 may include means, such as the processor 22 or the like, for identifying a transient object that is not in the image of the location, but that is anticipated to be at the location during at least one period of time. In this regard, the apparatus, such as the processor, may access information, such as information stored by the memory 24, that identifies the locations at which one or more transient objects will be positioned and, in one embodiment, the one or more periods of time during which the transient objects will be positioned at the respective locations. Based upon the location of the image to be presented, the apparatus, such as the processor, may identify a transient object that is scheduled to be at the same location during one or more periods of time, even though the transient object is not in the image of the location, that is, not in a predefined image of the location stored in a database or not in an image of the location that is captured by the user.

As shown in block 34 of FIG. 3, the apparatus 20 of one embodiment may include means, such as the processor 22 or the like, for augmenting the image of the location with a representation of the transient object. The apparatus of this embodiment also includes means, such as the processor, the user interface 27 or the like, for causing the image of the location to be presented with augmentation that provides a representation of the transient object. See block 36 of FIG. 3. By way of example, the representation of the transient object with which the image of the location is augmented may be considered a separate layer that may be controllably activated and deactivated by the processor in order to alternately augment the image and prevent augmentation of the image, respectively, based upon whether the transient object is anticipated to be at the location during at least one period of time. In an embodiment in which the apparatus is embodied by a computing device of the user, the processor may cause the augmented image to be displayed upon the user interface, such as upon a display of the computing device. However, in an embodiment in which the apparatus is embodied by a computing device, such as a server, that is remote from the user, the processor, via the communication interface 26, may cause the augmented image to be transmitted to the computing device of the user so as to be presented by the computing device of the user, such as upon a display of the computing device of the user.

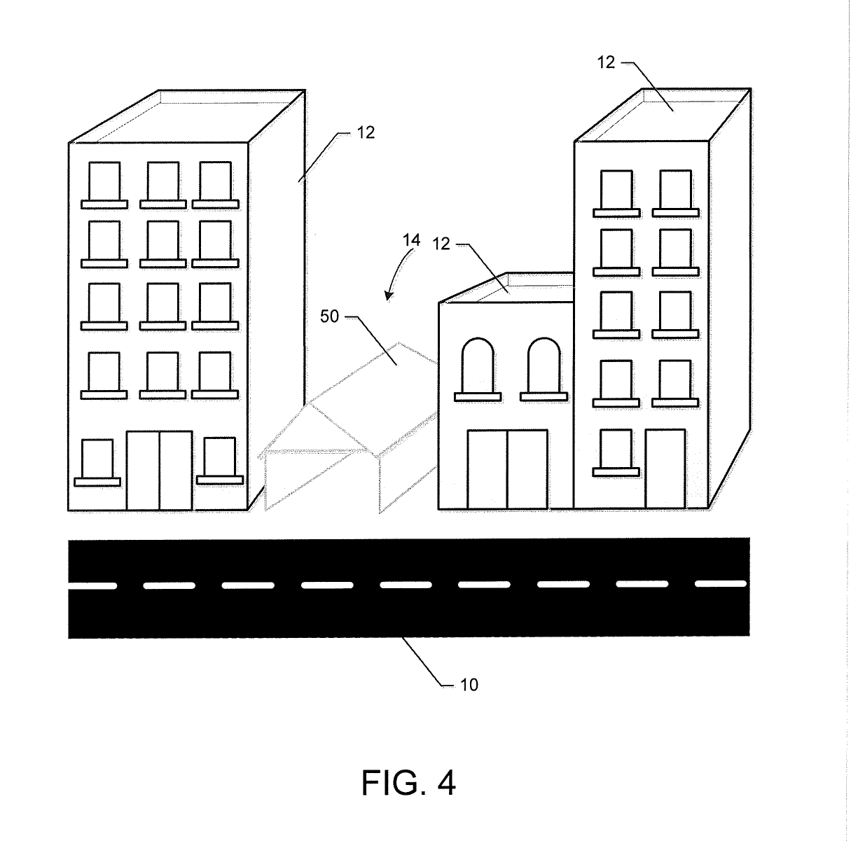

In one embodiment in which the transient object has a predetermined appearance, the apparatus 20, such as the processor 22, may augment the image of the location with a representation of the transient object that has the predetermined appearance of the transient object. As shown in FIG. 4, for example, a farmer's market may be periodically erected on an empty lot 14. The farmer's market of this embodiment may be housed by a tent such that the predetermined appearance of the transient object 50 is that of a tent. As such, the apparatus, such as the processor, of this embodiment may augment the image of the location, such as the image of the streetscape shown in FIG. 1, with an image of a tent representative of the farmer's market that periodically occupies the otherwise empty space along the street. Thus, the representation of the transient object of this embodiment may have the same predetermined appearance as the transient object itself.

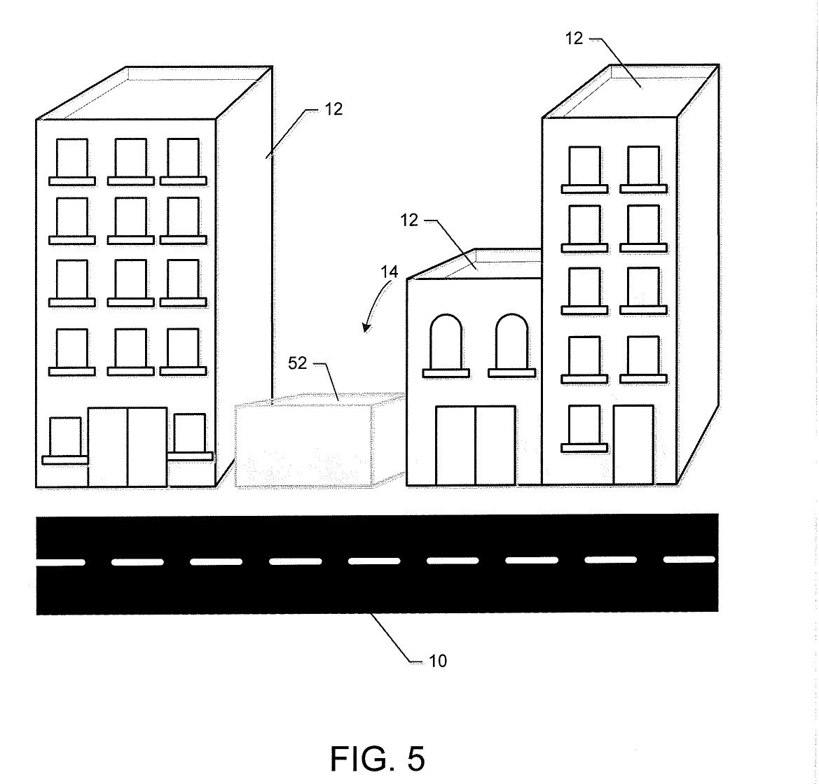

Alternatively, the apparatus 20, such as the processor 22, may augment the image of the location with a representation of the transient object that has a generic appearance. For example, FIG. 5 depicts a representation of a transient object 52 in the empty space 14 along the street 10 with the representation having a generic appearance. The representation of a transient object may have a generic appearance for any of a variety of different reasons. In one embodiment, however, a plurality of different transient objects may be positioned at the same location during different periods of time. Since the plurality of transient objects may have different appearances, the representation of the plurality of transient objects at the location may have a generic appearance so as to universally represent each of the plurality of different transient objects at the location.

Although the representation of the transient object may be presented in the same fashion as the remainder of the image, such as with lines having the same thickness and shade, the apparatus 20, such as the processor 22, of one embodiment may augment the image of the location with a representation of the transient object that is depicted in a manner that is visually distinguishable from the remainder of the image at a location. For example, the representation of the transient object in FIGS. 4 and 5 has more lightly shaded lines than the remainder of the image, such that the representation of the transient object is ghosted. However, the apparatus, such as the processor, may cause the representation of the transient object to be visually distinct from the remainder of the image of the location in other manners in other embodiments.

In one embodiment, the apparatus 20 may include means, such as the processor 22, the user interface 27 or the like, for receiving a request for information regarding the transient object. See block 38 of FIG. 3. The request may be provided in various manners. In one embodiment, however, a user may provide input via the user interface requesting additional information regarding the transient object. For example, the user may select the representation of the transient object with which the image of the location has been augmented, such as by placing a cursor upon the representation of the transient object or by touching a touch screen at a position coincident with the representation of the transient object. Regardless of the manner in which the request for information regarding the transient object is provided, the apparatus of this embodiment may include means, such as the processor, the user interface or the like, for causing information to be presented regarding the at least one period of time during which the transient object is anticipated to be at the location. See block 40 of FIG. 3. Various types of information may be provided. For example, the information to be presented regarding the transient object may include a timeline, such as a schedule, that identifies one or more periods of time during which the transient object is anticipated to be at the location. The timeline, e.g., schedule, may also identify one or more periods of time during which the transient object is not anticipated to be at the location.

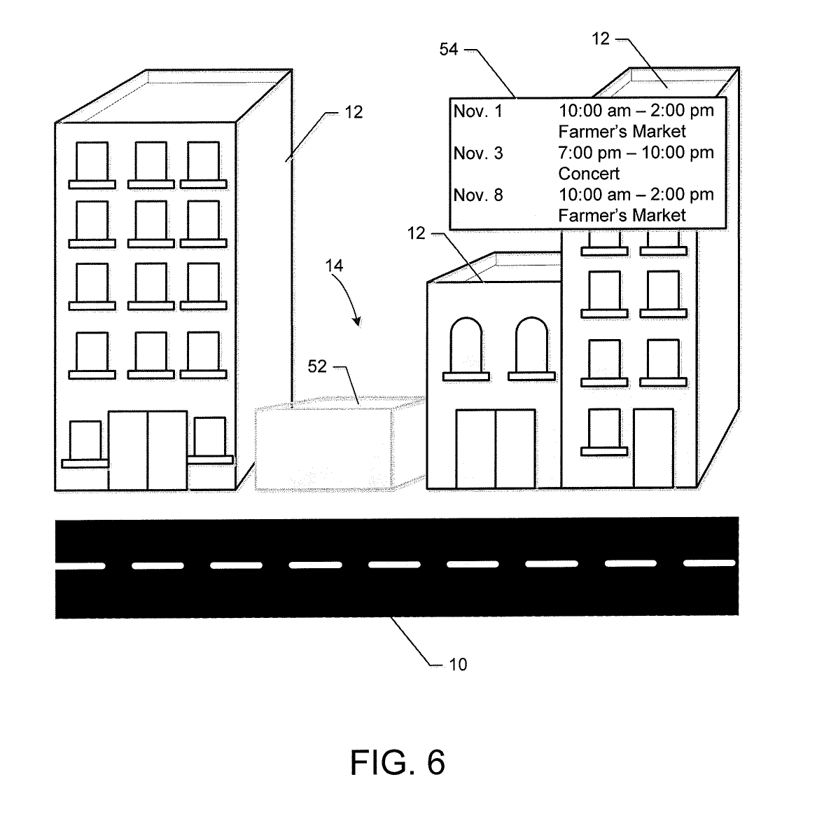

In one embodiment, one or more transient objects are anticipated to be at the location. As such, the apparatus 20 may include means, such as the processor 22, the user interface 27 or the like, for causing information to be presented regarding the transient object by causing a timeline, e.g., a schedule, to be presented of one or more periods of time during which the one or more transient objects are anticipated to be at the location. In an instance in which two or more transient objects are anticipated to be at the location, the timeline, e.g., the schedule, that is presented may include one or more periods of time during which each of the respective transient objects are anticipated to be at the location. By way of example, FIG. 6 depicts an image generated in response to a request for information regarding a transient object 52, generically represented by a rectangular solid, which includes information, such as a schedule 54, in regard to the various periods of times during which two different transient objects are anticipated to be at the same location. For example, a farmer's market is anticipated to be at the location on November 1 and November 8, from 10:00 am to 2:00 pm, while a concert is anticipated to be held at the location on November 3, beginning at 7:00 pm. By referring to the timeline, e.g., the schedule, a user may quickly determine the length of time that a transient object will be at the location.

In this embodiment, the apparatus 20 may include means, such as the processor 22, the user interface 27 or the like, for receiving an indication of a selected time from the timeline, e.g., the schedule. See block 42 of FIG. 3. For example, a user may select one of the entries from the schedule 54 that is presented. Alternatively, the user may select a time period between the entries listed by the timeline, e.g., the schedule. The apparatus of this embodiment may also include means, such as the processor or the like, for determining whether a respective transient object is anticipated to be the location at the selected time. See block 44. For example, the apparatus, such as the processor, may determine whether the farmer's market, a concert or any other transient object is anticipated to be the location at the selected time based upon the schedule of FIG. 6. The apparatus of this embodiment may also include means, such as the processor, the user interface or the like, for augmenting the image with the representation of the respective transient object that is anticipated to be at the location at the selected time. See block 46. For example, in an instance in which the selected time coincides with the farmer's market being at the location, the apparatus, such as the processor, the user interface or the like, may cause the augmented image of the location to change from the image shown in FIGS. 5 and 6 in which the transient object is represented with a generic appearance to the image shown in FIG. 4 in which the transient object is represented with the predetermined appearance of a tent so as to represent the farmer's market. While the method, apparatus and computer program product of this embodiment are described by way of example with respect to the transition from a representation of transient object having a generic appearance to a representation of a transient object having a predetermined appearance, other embodiments of the method, apparatus and computer program product may similarly transition between representations of the transient object having different predetermined appearances or between a representation of a transient object having a predetermined appearance and a representation of a transient object having a generic appearance.

As shown in FIG. 3, the apparatus 20, such as the processor 22, the user interface 27 or the like, may augment the image in an example embodiment only in an instance in which a respective transient object is anticipated to be the location at the selected time. Thus, in an instance in which no transient object is anticipated to be the location at the selected time, the apparatus, such as the processor, the user interface or the like, may cause the image of the location to be presented without augmentation as shown in block 48.

By way of example, a user may virtually explore a location by providing the address of the location. In response, the apparatus 20, such as the processor 22, may retrieve an image of the location. Since the image of the location was captured in the early morning, the image does not include the food trucks that congregate at the location during lunch. The apparatus, such as the processor, of this embodiment may identify the food trucks that congregate at the location during lunch. Thus, the apparatus, such as the processor, may augment the image of the location so as to include a representation of the food trucks that are anticipated to be at the location. As such, the image of the location that is presented has been augmented with a representation of the food trucks even though the image of the location that is retrieved from the database does not include the food trucks.

By way of another example, a user may capture an image, such as a video recording, of a location. Since the image of the location is captured in the early morning, the image does not include the food trucks that congregate at the location during lunch. The apparatus 20, such as the processor 22, of this embodiment may identify the food trucks that congregate at the location during lunch. Thus, the apparatus, such as the processor, may augment the image of the location so as to include a representation of the food trucks that are anticipated to be at the location. As such, the image of the location that is presented has been augmented with a representation of the food trucks, even though the food trucks are not currently at the location.

In one embodiment in which the apparatus 20 is embodied by a server or other network entity, the apparatus, such as the processor, may identify an image of a location to be presented, such as in response to an inquiry from a mobile terminal. For example, a mobile terminal may provide an indication of a location, such as an address, the name of a landmark, location coordinates as provided by a GPS or the like. In response, the apparatus, such as the processor, may identify an image of the location, such as from memory 24, and may then provide the image of the location to the mobile terminal. The apparatus, such as the processor, embodied by a server or other network entity may also identify a transient object that is not in the image of the location, but that is anticipated to be at the location during at least one period of time. For example, the apparatus, such as the processor, may access the memory that may include information regarding transient object(s) that are anticipated to be at respective locations. As such, in an instance in which the apparatus, such as the processor, embodied by a server or other network entity, identifies a transient object that is not in the image of the location, but that is anticipated to be at the location during at least one period of time, the apparatus may provide information regarding the transient object to a mobile terminal. In one embodiment, the apparatus, such as the processor, the communications interface 26 or the like, may cause information defining a representation of the transient object to be provided to the mobile terminal such that the mobile terminal may thereafter display the image of the location with augmentation that provides a representation of the transient object, thereby causing the image of the location to be presented with augmentation that provides the representation of the transient object. In one embodiment, the apparatus, such as the processor, embodied by the server or other network entity may also retrieve information, such as a schedule, from memory and then provide information, such as the schedule, to the mobile terminal regarding at least one period of time during which the transient object is anticipated to be at the location.

As described above, FIG. 3 is a flowchart of an apparatus, method, and computer program product according to an example embodiment of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 24 of an apparatus 20 employing an embodiment of the present invention and executed by a processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

In some embodiments, certain ones of the operations above may be modified or further amplified as described below. Moreover, in some embodiments additional optional operations may also be included (some examples of which are shown in dashed lines in FIG. 3). It should be appreciated that each of the modifications, optional additions or amplifications below may be included with the operations above either alone or in combination with any others among the features described herein.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
identifying an image of a location to be presented;
identifying, with a processor, a transient object that is not in the image of the location, but that is anticipated to be at the location during at least one period of time; and
causing the image of the location to be presented with augmentation that provides a representation of the transient object.

2. A method according to claim 1 wherein the transient object has a predetermined appearance, and wherein the method further comprises augmenting the image of the location with the representation having the predetermined appearance of the transient object.

3. A method according to claim 1 further comprising augmenting the image of the location with the representation of the transient object having a generic appearance.

4. A method according to claim 1 further comprising:
receiving a request for information regarding the transient object; and
causing information to be presented regarding the at least one period of time during which the transient object is anticipated to be at the location.

5. A method according to claim 4 wherein one or more transient objects are anticipated to be at the location, wherein causing information to be presented comprises causing a schedule to be presented of the at least one period of time during which the one or more transient objects are anticipated to be at the location, wherein the method further comprises:
receiving an indication of a selected time from the schedule;
determining whether a respective transient object is anticipated to be at the location at the selected time; and
augmenting the image, only in an instance in which a respective transient object is anticipated to be at the location at the selected time, with the representation of the respective transient object that is anticipated to be at the location at the selected time.

6. A method according to claim 5 wherein causing the image of the location at the selected time to be presented with augmentation comprises augmenting the image of the location with the representation of the respective transient object that is anticipated to be at the location at the selected time.

7. A method according to claim 1 wherein identifying the image of the location comprises at least one of causing the image of the location to be retrieved from a database or causing the image of the location to be captured.

8. An apparatus comprising at least one processor and at least one memory including computer program code, the at least one memory and the computer program code configured to, with the processor, cause the apparatus to at least:
identify an image of a location to be presented;
identify a transient object that is not in the image of the location, but that is anticipated to be at the location during at least one period of time; and
cause the image of the location to be presented with augmentation that provides a representation of the transient object.

9. An apparatus according to claim 8 wherein the transient object has a predetermined appearance, and wherein the at least one memory and the computer program code are further configured to, with the processor, cause the apparatus to augment the image of the location with the representation having the predetermined appearance of the transient object.

10. An apparatus according to claim 8 wherein the at least one memory and the computer program code are further configured to, with the processor, cause the apparatus to augment the image of the location with the representation of the transient object having a generic appearance.

11. An apparatus according to claim 8 wherein the at least one memory and the computer program code are further configured to, with the processor, cause the apparatus to:
receive a request for information regarding the transient object; and
cause information to be presented regarding the at least one period of time during which the transient object is anticipated to be at the location.

12. An apparatus according to claim 11 wherein one or more transient objects are anticipated to be at the location, wherein the at least one memory and the computer program code are configured to, with the processor, cause the apparatus to cause information to be presented by causing a schedule to be presented of the at least one period of time during which the one or more transient objects are anticipated to be at the location, wherein the at least one memory and the computer program code are further configured to, with the processor, cause the apparatus to:
receive an indication of a selected time from the schedule;
determine whether a respective transient object is anticipated to be at the location at the selected time; and
augment the image, only in an instance in which a respective transient object is anticipated to be at the location at the selected time, with the representation of the respective transient object that is anticipated to be at the location at the selected time.

13. An apparatus according to claim 12 wherein the at least one memory and the computer program code are configured to, with the processor, cause the apparatus to cause the image of the location at the selected time to be presented with augmentation by augmenting the image of the location with the representation of the respective transient object that is anticipated to be at the location at the selected time.

14. An apparatus according to claim 8 wherein the at least one memory and the computer program code are configured to, with the processor, cause the apparatus to identify the image of the location by at least one of causing the image of the location to be retrieved from a database or causing the image of the location to be captured.

15. A computer program product comprising at least one non-transitory computer-readable storage medium having computer-executable program code portions stored therein, the computer-executable program code portions comprising program code instructions for:
identifying an image of a location to be presented;
identifying a transient object that is not in the image of the location, but that is anticipated to be at the location during at least one period of time; and
causing the image of the location to be presented with augmentation that provides a representation of the transient object.

16. A computer program product according to claim 15 wherein the transient object has a predetermined appearance, and wherein the computer-executable program code portions further comprise program code instructions for augmenting the image of the location with the representation having the predetermined appearance of the transient object.

17. A computer program product according to claim 15 wherein the computer-executable program code portions further comprise program code instructions for augmenting the image of the location with the representation of the transient object having a generic appearance.

18. A computer program product according to claim 15 wherein the computer-executable program code portions further comprise program code instructions for:
receiving a request for information regarding the transient object; and
causing information to be presented regarding the at least one period of time during which the transient object is anticipated to be at the location.

19. A computer program product according to claim 18 wherein one or more transient objects are anticipated to be at the location, wherein the program code instructions for causing information to be presented comprise program code instructions for causing a schedule to be presented of the at least one period of time during which the one or more transient objects are anticipated to be at the location, wherein the computer-executable program code portions further comprise program code instructions for:
receiving an indication of a selected time from the schedule;
determining whether a respective transient object is anticipated to be at the location at the selected time; and
augmenting the image, only in an instance in which a respective transient object is anticipated to be at the location at the selected time, with the representation of the respective transient object that is anticipated to be at the location at the selected time.

20. A computer program product according to claim 19 wherein the program code instructions for causing the image of the location at the selected time to be presented with augmentation comprise program code instructions for augmenting the image of the location with the representation of the respective transient object that is anticipated to be at the location at the selected time.
